(19) United States
(12) Patent Application Publication
(10) Pub. No.: US 2007/0038777 A1
(43) Pub. Date: Feb. 15, 2007

(54) Conversation message server

(75) Inventors: Sydney Gordon Low, Kew (AU); Matthew Iain Walker, Heidelberg Heights (AU); Peter Yandell, Prahran (AU)

Correspondence Address: NIXON & VANDERHYE, PC, 901 NORTH GLEBE ROAD, 11TH FLOOR, ARLINGTON, VA, 22203, US

(73) Assignee: Alien Camel Pty LTD, Victoria (AU)

(21) Appl. No.: 11/454,126

(22) Filed: Jun. 16, 2006

Related U.S. Application Data
(60) Provisional application No. 60/691,255, filed on Jun. 17, 2005.

(30) Foreign Application Priority Data
Jun. 17, 2005 (AU) 2005903187

(51) Int. Cl. G06F 15/16

(52) U.S. Cl. 709/245

(57) ABSTRACT

A conversation message server, including: a receive process component for receiving a creation message sent to a creation address; an establish process component for generating, in response to the creation message, a conversation address, storing other addresses of the creation message as addresses of participants to a conversation corresponding to the conversation address; and a send process component for sending a conversation notification message to the participants at the addresses to advise of the conversation address.

### FIELD

The present invention relates to a conversation message server and a conversation process.

### BACKGROUND

Electronic messages, such as email or SMS (short message service) messages, allow a sender and recipient to establish a conversation, albeit in discreet time periods, by regularly replying to each message sent. The conversation may be on a particular topic, represented by text placed in the subject field of the messages, yet over time may cover a variety of topics. Maintaining conversations of this type between a number of addressed parties, ie participants, can prove difficult to follow, maintain and manage.

For example, if standard email is used for a conversation amongst a number of participants, it is relatively easy to establish because an initiator of the conversation simply needs to send an initial email with the addresses of the other participants in the “to” or “cc” fields of the initial email. The participants may then use the ‘reply to all’ function, available in most email clients, to ensure all of the participants are addressed in any replies, to maintain the conversation. Additional participants can be easily added by any of the current participants by adding addresses to the “to” and “cc” fields. The addresses normally can be sourced from a contacts management component of most email clients, such as Outlook by Microsoft Corporation and Mail by Apple Computer Inc.

One of the problems in using standard email to maintain a conversation is that each sender needs to ensure recipient addresses are added for the participants to every email in order to ensure all participants continue to participate in the discussion. There is no management or control over whether subsequent emails in the conversation will include the addresses of the original participants, as it is simply up to subsequent senders to remember to add and maintain all participants. There is no central control on who receives the messages of the conversation. There is also no archive management which enables past conversations to be retrieved, nor is there any integrated SPAM or virus management.

For this reason, central server systems have been established to provide electronic bulletin boards, news groups and now web based discussion forums that allow a service provider to establish a location on the server system where participants to a conversation can post messages on a topic. Whilst these forums provide centralised management by the service provider, they must be established by the provider of the server system or operate under the control of a forum establishment application made available on the system by the provider. This is restrictive and does not allow impromptu conversation. The forum must first be established and all messages can only be submitted and obtained by logging onto the central system.

Another available alternative is mailing list management software, such as Majordomo, or mailing lists managed on web sites, such as Yahoogroups.com. The mailing lists managed by list server software, such as Majordomo and Listserv, and those managed by web site scripts, such as at http://www.yahoogroups.com, operate in a similar manner in that an email sent to a single address, such as ABC@yahoogroups.com, will result in that email being automatically forwarded to all of the email addresses in the mailing list. This has the advantage that instead of having to ensure that the participant addresses are in the email being sent, only one list address needs to be included in the email to, cc or bcc field of the email. The addresses of the participants are maintained using the list server software or on the web site of the list provider. This immediately raises the problem that at least one of the participants must maintain the list using the available software or site. For example, for a web site mailing list a participant to the intended conversation needs to set up the group via the web site by creating an account, adding a list of email addresses, starting the email discussion and then if desired, adding more email addresses. Addresses need to be copied and pasted from contact management software on a client device of the participant. This is relatively cumbersome and is not integrated with the email software on the client device. Also, web site archives of the emails are not generally grouped by a conversation topic, nor is there integrated SPAM and virus management.

Discussion web sites are available, such as at http://www.conversate.org, which seek to address some of the deficiencies of normal mailing lists. Again, an email can be sent to a single email address, and all participants will be forwarded a copy of the email, once a discussion has been established. A web site archive organised by conversation topic is available. This still, however, has the same deficiency that an account must be established first with the central site. Once the account is established, then email addresses of the participants need to be added and submitted to the web site, again by copying and pasting a list from contact management software of a client device. Accordingly, the same management issues that are problematic for mailing lists are also not addressed. Furthermore, there is also no integrated SPAM and virus management.

Accordingly, it is desired to address the above deficiencies associated with establishing and maintaining a conversation using electronic messages, or at least provide a useful alternative.

### SUMMARY

In accordance with the present invention there is provided a conversation message server, including:

a receive process component for receiving a creation message sent to a creation address;

an establish process component for generating, in response to said creation message, a conversation address, storing other addresses of said creation message as addresses of participants to a conversation corresponding to said conversation address; and

a send process component for sending a conversation notification message to said participants at said addresses to advise of said conversation address.

Preferably the conversation message server further includes a forward process component for forwarding a conversation message received by said receive process component with said conversation address to said addresses of said participants, using said send processing component. The forward process component may process the conversation message to determine if the conversation message includes any further recipient addresses other than the stored addresses of said participants, and said establish process component stores said further addresses as addresses of further participants to said conversation. The forward process component and send process component preferably sends said conversation notification message to said further addresses of said further participants. The forward process component and the send process component may also send a new participant message to existing participants notifying of the addition to said conversation of said further participants.

Advantageously, the send process component may include at least content of a first message, being said creation message or said conversation message including any further recipient addresses, in said conversation notification message, when an addressee of said first message uses a predetermined process or service wherein said addressee does not receive said first message. The send component determines said first message will not be received for an address based on conversation aware data, of said first message or stored for said addressee by said server.

The present invention also provides a conversation process, performed by a computer system, including:

receiving a creation message sent to a creation address;

generating, in response to said creation message, a conversation address, storing other addresses of said creation message as addresses of participants to a conversation corresponding to said conversation address; and

sending a conversation notification message to said participants at said addresses to advise of said conversation address.

The present invention also provides a conversation process, performed by a computer device, including:

sending a creation message to a creation address, wherein, in response to said creation message, a conversation address is generated, and other addresses of said creation message are stored as addresses of participants to a conversation corresponding to said conversation address; and

receiving a conversation notification message sent to said participants at said addresses to advise of said conversation address.

### DRAWINGS

Preferred embodiments of the present invention are hereinafter described, by way of example only, with reference to the accompanying drawings, wherein:

FIG. 1 is a block diagram of a preferred embodiment of a conversation message server system;

FIG. 2 is a flow diagram of a first process performed by components of a conversation message server of the system;

FIGS. 3 and 4 are flow diagrams of a second alternative process performed by the conversation server;

FIGS. 5 to 10 are diagrams illustrating message handling processes performed by the conversation server; and

FIGS. 11 and 12 are screen displays provided by the conversation server.

### DETAILED DESCRIPTION OF PREFERRED EMBODIMENTS

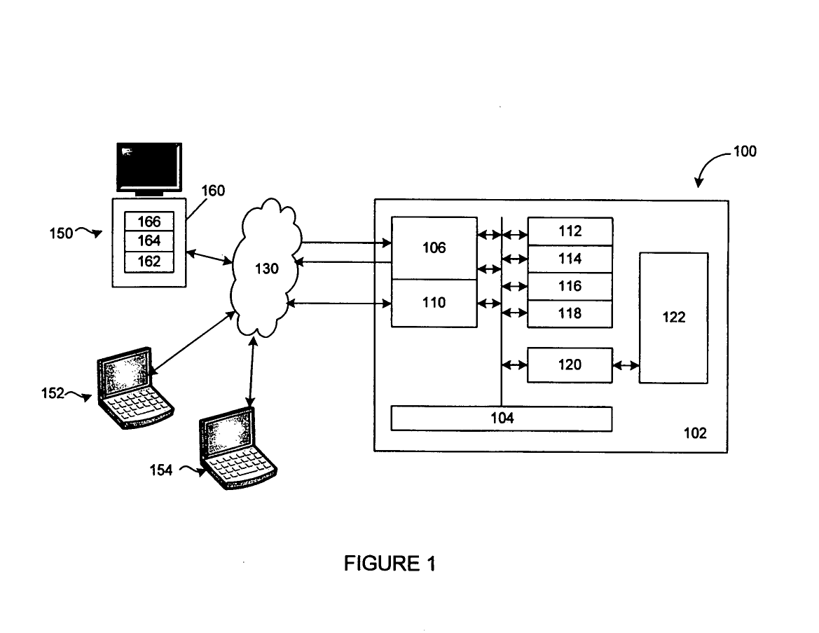

A conversation message server system, as shown in FIG. 1, includes a conversation message server 100 that communicates with client devices 150, 152, 154 of participants to a conversation, using a communications network 130. For the purposes of this description, the communications network 130 is described as one that supports the TCP/IP protocols, such as the Internet, and the message server 100 is described as an email server conforming to RFC 2821. It will be understood by those skilled in the art that it is possible to adapt the server 100 to operate over different communication networks, and handle other electronic messages using different protocols. The client devices 150, 152, 154 are computer systems able to communicate with the communications network 130 and handle the receipt and sending of electronic messages. The devices 150, 152 and 154 may be a mobile telephone or personal digital assistant (PDA). The devices 150, 152, 154 are hereinafter described as being a standard personal computer 160, such as that provided by Lenovo Group Limited (http://www.lenovo.com), running an operating system 162, such as Microsoft Windows or Linux, with email client software 164, such as Microsoft Outlook, and a web browser 166, such as Internet Explorer, Safari or Firefox.

The conversation server 100 is a server computer system 102, such as that provided by IBM Corporation, running an operating system 104, such as Windows Server 2003, Linux, Unix or Solaris. The conversation server 100 includes an email server software application 106, such as Sendmail or Microsoft Exchange, to enable the server to receive and send emails using Internet protocols, such as SMTP. The server 100 may also include application code 106 to allow the client devices 150, 152, 154 to access messages directly using POP and IMAP, instead of from the equipment of an Internet service provider (ISP) on the communications network 130. A web server 110 on the conversation server 100 allows the client devices 150 to 154 to access archived messages of conversations. It will be understood by those skilled in the art that it is possible to adapt the server 100 to allow the client devices 150, 152, 154 to access new and archived messages using other protocols like POP, IMAP, RSS and NNTP without the need for a web browser. The conversation server 100 includes a number of process component modules 112, 114, 116 and 118 comprising computer program instruction code in languages such as Java (http://www.java.sun.com), Perl (http://www.perl.org), HTML and XML for processing the messages handled by the server 100. A database server 120, such as MySQL4 (http://www.mysql.org), is used to maintain a database 122 to support the processing performed by the email server 106, the web server 110 and the component modules 112 to 118. It will also be understood by those skilled in the art that the components 106 to 122 of the conversation server 100 could also be placed on a number of distributed computers connected by the communications network 130, and also the processes executed by the components could also be executed at least in part by dedicated hardware circuits, eg ASICs and FPGAs.

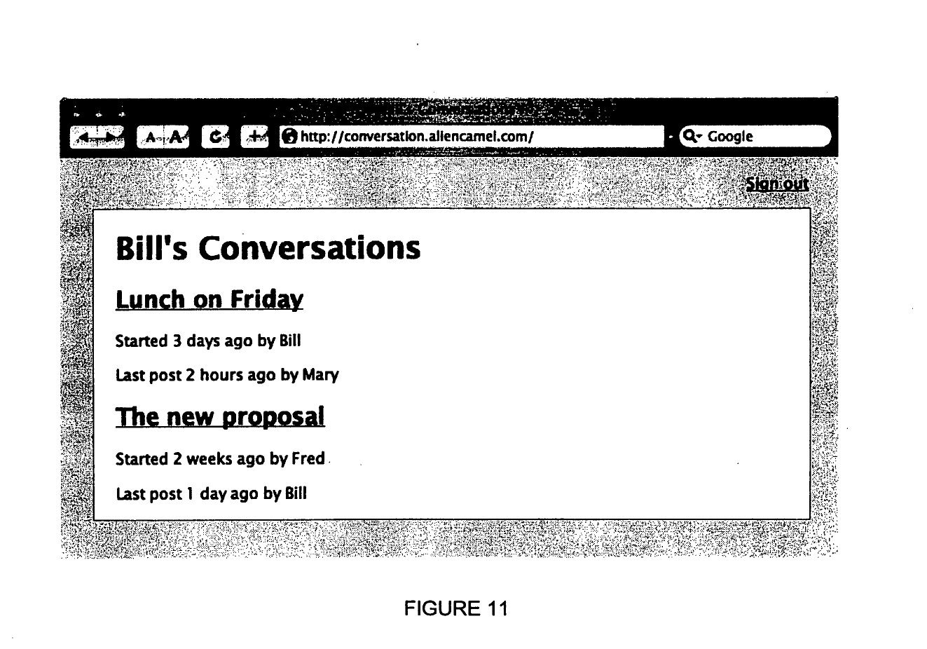

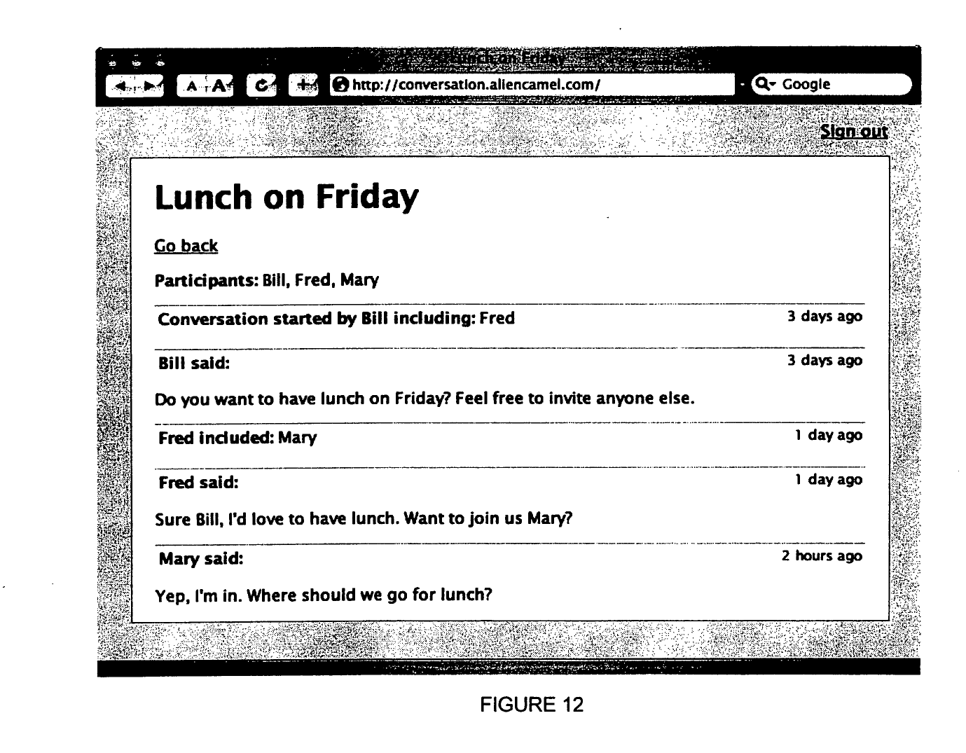

The conversation server 100 is connected to the communications network 130 such that the email server 106 receives messages addressed to a single creation address, eg start@conversation.aliencamel.com, and for each conversation, receives messages addressed to a separate conversation address, eg 123@conversation.aliencamel.com. A receive module 112 determines whether the emails received by the email server 106 are addressed to a new conversation, ie the creation address, or to a particular existing conversation, determined by a conversation address. An establishment process component module 114 processes messages addressed to the creation address so as to store the addresses of the participants in the database 122 using the database server 120, and attends to generation of a unique conversation address for a conversation. A send process component module 116 controls the email server 106 to handle the sending of new conversation notification messages and conversation messages to participants. A forward process module 118 controls the creation of messages for participants in the conversation, and the addition of additional participants to be added to the database 122 for a conversation. The web server 110 includes web server software, such as Apache (http://www.apache.org/), HTML code and script code that allows the server 100 to provide a web interface to the client devices 150, 152, 154 giving access to messages archived in the database 122. The messages are accessible based on conversation, defined by a conversation address, and topic defined by the subject field of emails of the conversation. The interface is able to display the chronological history and relationship between the messages as shown in FIGS. 11 and 12.

A user of a client device 150 is able to create a conversation with one or more other participants by sending an email, using the client device 150, addressed to a creation address, eg start@conversation.aliencamel.com, of the conversation server 100. The email needs to also include the addresses of one or more other participants as recipients in the header of the email, eg
From: [Sender]
To: [recipient 1], [recipient 2], . . . [recipient n], [conversation creation address]
Subject: [subject]
[message body]

The terms “email”, “envelope”, “header”, and “body” used herein are explained in Internet RFC 2821 (http://www.ietf.org/rfc/rfc2821.txt), such as in Section 2.3.1 on Mail Objects.

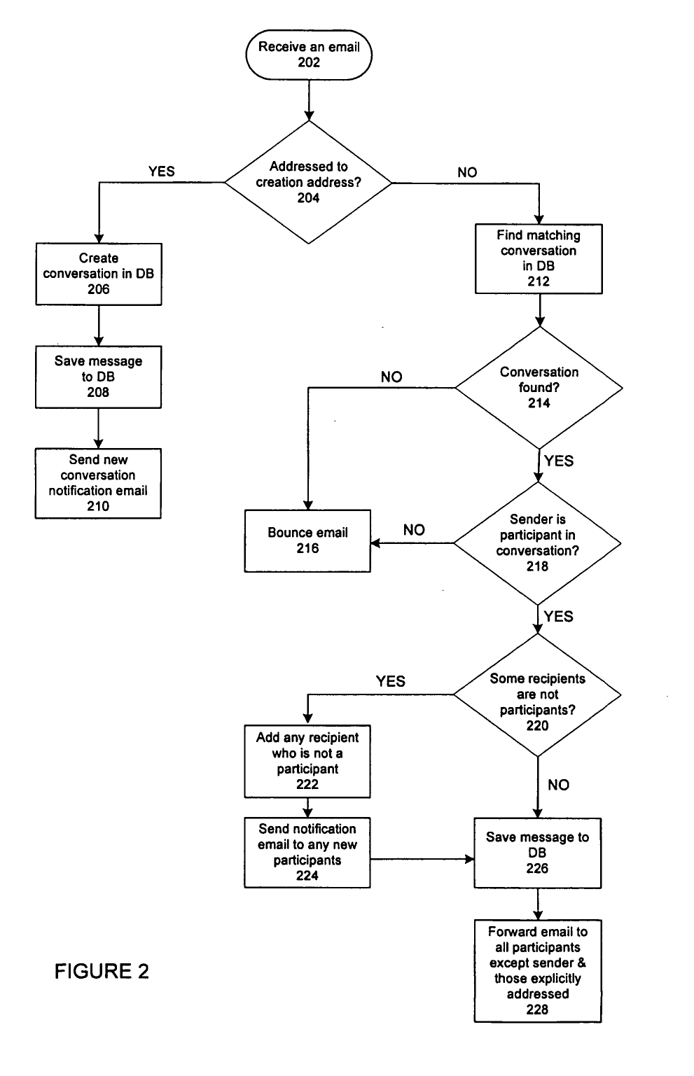

The email server 106 receives all emails from the communications network 130 addressed to the conversation creation address, and emails addressed to individual conversation addresses. On receiving an email, step 202 of FIG. 2, the receive module 112 processes the email to determine whether it is addressed to the creation address (step 204). If the email is addressed to the creation address, ie the creation address is included in the envelope of the email, the email is further processed by the establishment module 114 so as to create a conversation (step 206). A conversation is created by the establishment module 114 generating a conversation address for the conversation, eg 123@conversation.aliencamel.com, and then persisting entries in the database 122 to link the conversation address to all the other addresses in the header of the email, ie the sender and recipient addresses. The sender and recipient addresses are stored as addresses for participants of the conversation, and the subject of the email is stored as the topic of the conversation. Once these data entries are linked and stored in the database 122 (step 208) notification emails are generated and sent to all of the participants, including the initial sender, to notify the participants of the conversation address for the conversation. The notification emails are generated by the send component module 116 (step 210) and are of the form:
From: [sender]
To: [recipient 1], [recipient 2], . . . [recipient n]
Reply-To: [conversation address]
Subject: [subject]
[new conversation notification message]

This ease of establishment of a conversation is a significant feature of the conversation server 100. This is achieved by simply having an initiator send an email to the conversation creation address and to other participants, and all of the participants are advised of the conversation address, which is to be used to continue the conversation. The conversation and the participant addresses are bound to the newly created conversation address in the database 122.

To continue a conversation, any participant can use a client device 150, 152, 154 to send an email to the conversation address for that conversation. For example, the continuing message may be of the form:
From: [sender]
To: [conversation address]
Subject: [subject]
[message body]

The receive module 112 determines (step 204) on receiving the email (step 202) that it is not addressed to a creation address, and the email is further processed by the forward component 118 which uses the database server 120 to try and locate a conversation matching the recipient address in the envelope of the email (212). If a conversation cannot be located in the database 122 that matches the conversation address (214) then the send component 116 is instructed to use the email server 106 to send a bounce email (216) back to the sender address. The bounce email advises that the conversation address does not exist or the sender is not a participant in the conversation corresponding to the conversation address. If a conversation is located (214) then the forward component 118 performs a further check to determine whether the sender address corresponds to a participant address for the conversation (218). If the sender of the email does not correspond to a participant of the conversation, then again the send component 116 sends a bounce email (216). The forward component 118 then determines whether the email contains any other addresses other than the sender address or the conversation address (220) and if not, then the message, or selected parts of the message, is saved in a database 122 and linked to the conversation (226). The forward component 118 then instructs the send component 116 to generate an email to forward the message to all of the participants (other than the sender and participants separately and directly addressed) and importantly includes in the “reply to” field of the header, the conversation address as the reply to address. For example, the forward email generated is in the following form:
From: [sender]
To: [participant 1], [participant 2], . . . [participant n]
Reply-To: [conversation address]
Subject: [subject]
[message body]

The send component 116 uses the email server 106 to send the forward email.

An existing participant can also readily add additional participants to a conversation. This is done by the sender sending an email to the conversation address with one or more additional recipient addresses, such as follows:
From: [sender]
To: [conversation address], [additional recipient 1], [additional recipient 2], . . . [additional recipient n]
Subject: [subject]
[message body]

The forward component 118 in processing an email addressed to the conversation address determines whether additional recipient addresses are included in the email, which are not already participants to the identified conversation (step 220). If so, the forward component 118 instructs the establishment component 114 to add the additional recipient addresses as participant addresses by storing them in the database 122 against the conversation (step 222). The forward component 118 then instructs the send component 116 to generate a notification email for the new additional recipients to advise them of the conversation address, and this is sent to the new participants by the email server 106 (step 224). A confirmation email may also be sent to existing participants advising that the new recipients have been added. The notification email for each new additional recipient is in the form:
From: [sender]
To: [additional recipient 1], [additional recipient 2], . . . [additional recipient n]
Reply-To: [conversation address]
Subject: [subject]
[inclusion in conversation notification message]

The message sent to the conversation address with the additional recipients is stored in the database 122 against the conversation (226), and the forward component 118 causes generation of a new email message to send to all participants in the conversation, except the sender, the additional recipients, and any other participant separately and directly addressed (228). The email is in the form:
From: [sender]
To: [participant 1], [participant 2], . . . [participant n]
Reply-To: [conversation address]
Subject: [subject]
[message body]

The process executed by the conversation server 100, as described above, involves participants receiving two emails when they are added to the conversation, one being the message initially sent by the sender to the new participant, and the second being the notification email sent by the send component 116 advising of the conversation address. For example, if an initiator, Fred with an address fred@fred.com, wishes to start a conversation about “Sunday lunch” with participants, Mary (with address mary@mary.com) and Bill (with address bill@bill.com), Fred may compose and arrange for an email to be sent as follows:
From: fred@fred.com
To: mary@mary.com, bill@bill.com, start@conversation.aliencamel.com
Subject: Sunday lunch
What's everyone doing for lunch this Sunday?

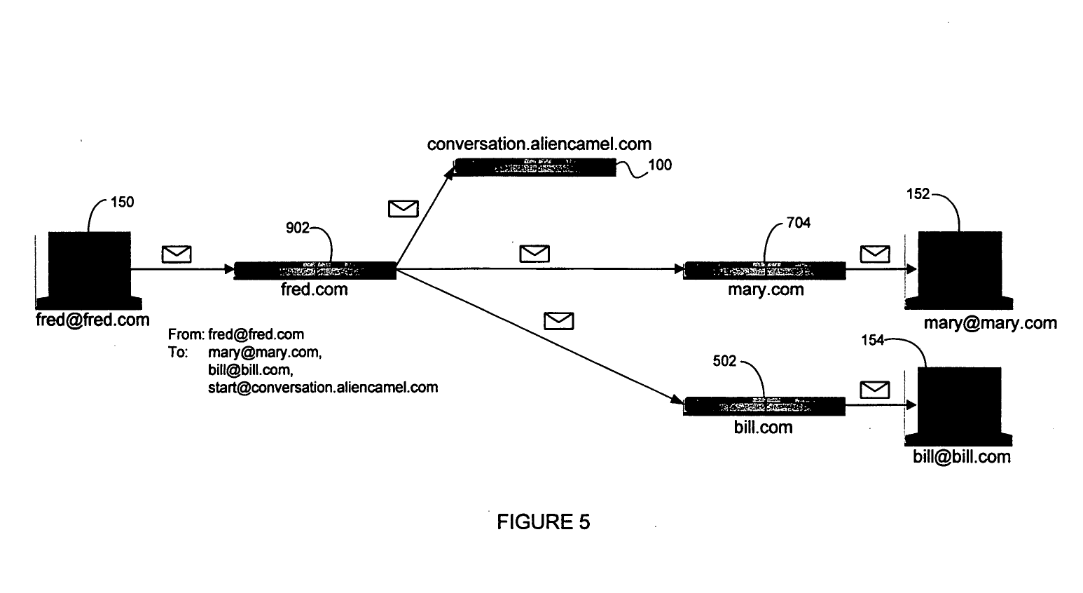

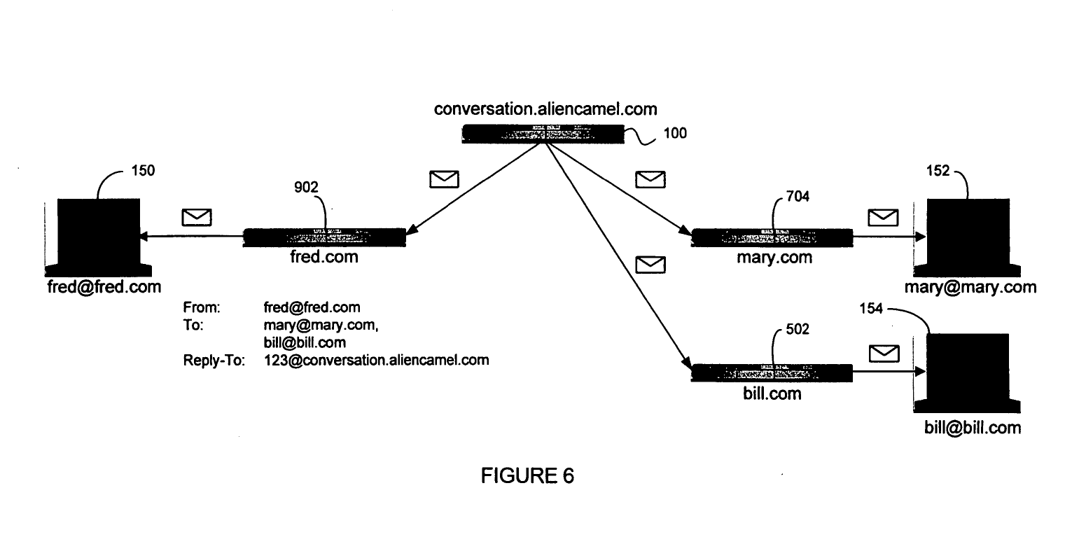

In this example, Mary and Bill receive an email directly from Fred, as shown in FIG. 5. The conversation server 100, as described above, also receives the email which is recognized as Fred requesting the creation of a new conversation. The conversation server 100 then sends out an email advising the participants that a conversation has been created and notifying them of the conversation address, as shown in FIG. 6. For example the email may be in the form:
From: “Fred via Conversation Service” <fred@aliencamel.com>
To: mary@mary.com, bill@bill.com
Reply-to: 123@conversation.aliencamel.com
Subject: Conversation about “Sunday lunch”
Hi, you may have received an email from me already about “Sunday lunch”. It said: “What's everyone doing for lunch this Sunday?”
I've started an email-conversation using this service. The service creates a magic email address <123@conversation.aliencamel.com> that includes all of us in the email. All you have to do click “reply” to this email—you can just ignore the other one.

The conversation server 100 can identify some email addresses as being “conversation-aware”, either by maintaining a list of conversation-aware addresses or domains or both in the database 122, or by being notified dynamically of conversation-aware addresses in a particular email by information in the header or envelope of that email. Email servers or email clients for conversation-aware email addresses detect any email addressed to the conversation creation address or individual conversation addresses and deliver it only to the conversation server 100 and not to any other addressed recipients. In response to the conversation-aware entries made in the database 122 or a dynamic notification, the conversation server 100 then forwards the email to recipients to whom delivery was initially blocked, combining notification of new participants with the body of the original blocked message in a single email, as discussed below. The following describes processes performed by email servers 702 and 706 to handle conversation-aware email addresses, but those skilled in the art will understand the processes could equally be performed by email clients for conversation-aware addresses, or by a combination of servers and clients.

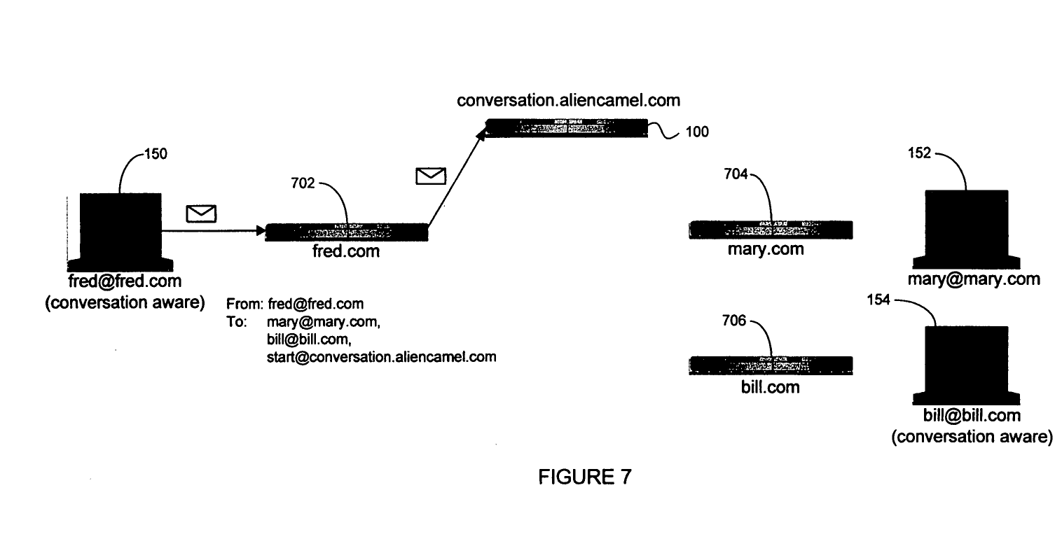

For example, if Fred's email address is conversation-aware, then the email server 702 of Fred's email service provider will identify the initial email sent by Fred as relating to the start of a new conversation because it contains the creation address start@conversation.aliencamel.com as one of the recipients in the email. Accordingly, it only delivers it to the conversation server 100 and not to the servers 704 and 706 of any other addressed recipients, as shown in FIG. 7.

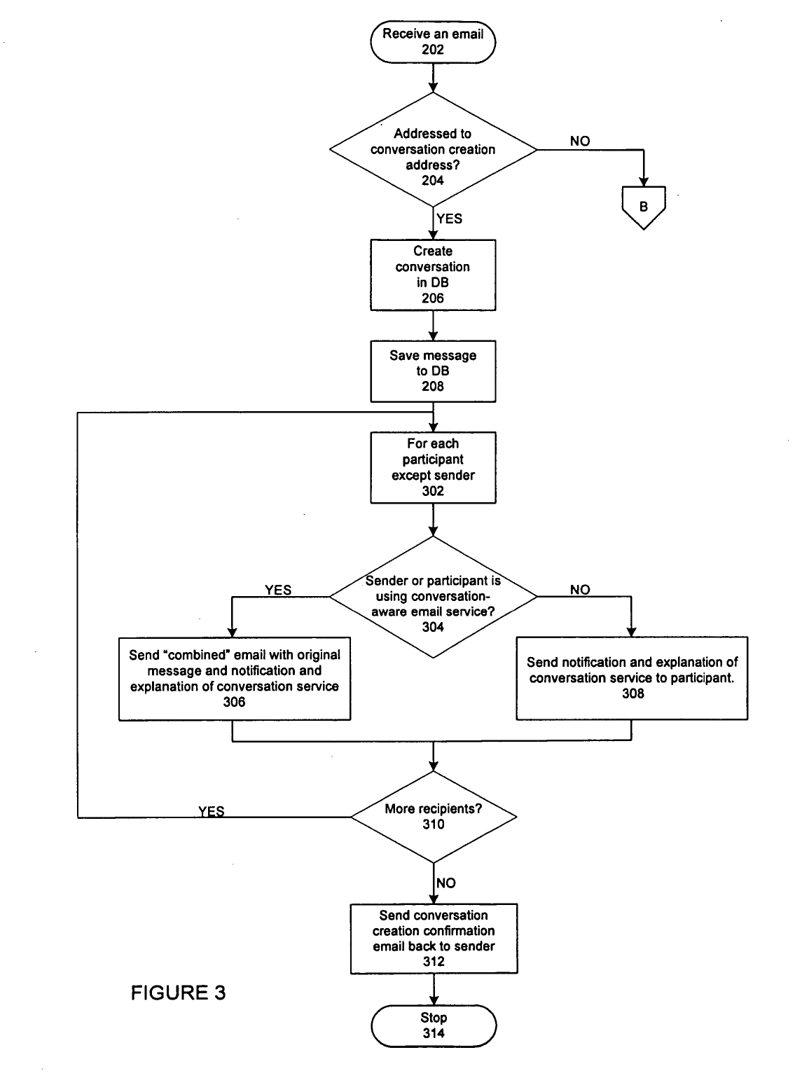

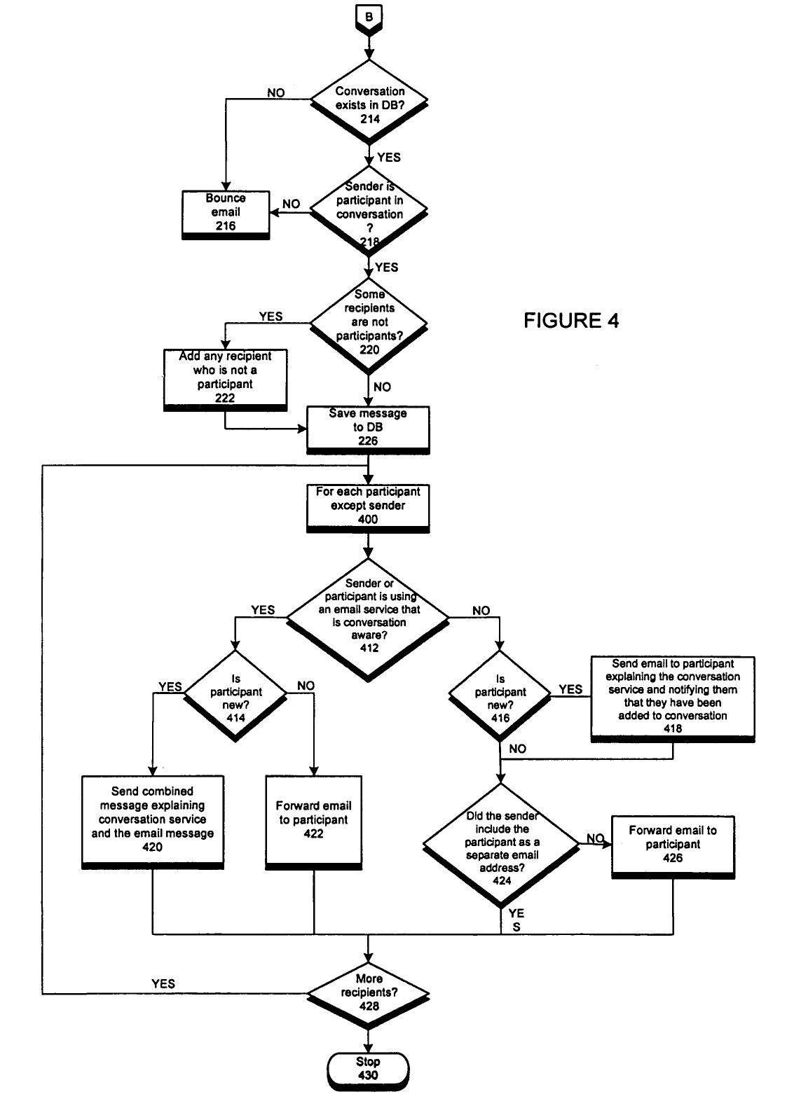

The conversation server 100 in processing Fred's initial email performs a second conversation process as shown in FIGS. 3 and 4. In the second conversation process, the send component 116 has been configured to operate depending on whether a sender or participant is using a conversation-aware email service.

The initial steps 202 to 208 of the second conversation process are the same as described previously, except once the send component 116 is called to send a notification message after the database entries are made at step 208, the send component 116 begins execution of a loop for each addressed participant in the new conversation, except the sender (step 302). A determination is made whether the sender address or participant address corresponds to a conversation-aware email service by accessing the conversation-aware entries made in the database 122 or acting on any dynamic notification received (step 304). If either the sender or the participant is using a conversation-aware email service, then a combined email with the original initiating message and a notification is generated and queued to be sent by the server 106 (step 306) for this participant. For example, if Fred's email service has been flagged as being conversation-aware and the original message has been withheld by Fred's server 702, then the send component 116 generates the following combined email 802:
From: “Fred via Conversation Service” <fred@fred.com>
To: mary@mary.com, bill@bill.com
Reply-to: 123@conversation.aliencamel.com
Subject: Conversation about “Sunday lunch”
What's everyone doing for lunch this Sunday?
By the way, I'm using a new email service that creates a magic email address <123@conversation.aliencamel.com> that will automatically email all of us in the future. All you have to do click “reply”.

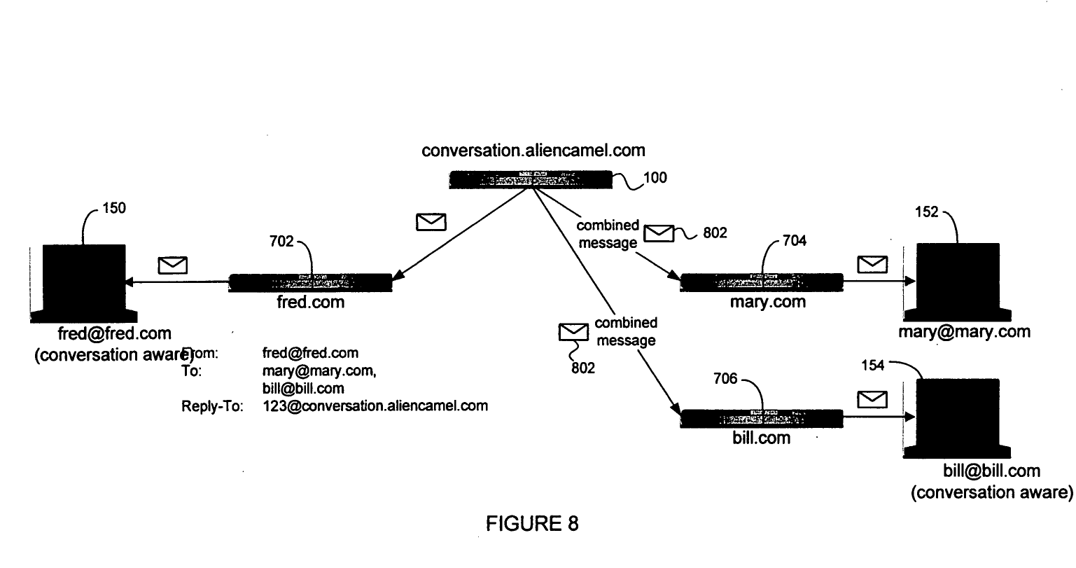

The combined email 802 is sent by the conversation server 100 to the servers 704, 706 for Mary and Bill, and Fred receives a confirmation message advising of the conversation address, as shown in FIG. 8.

Accordingly, the recipients do not receive two email messages when Fred starts the conversation. For each loop only one participant is addressed in an email envelope but all participants are shown in the “to” header display fields. Alternatively, the “to” header field may contain only the conversation address.

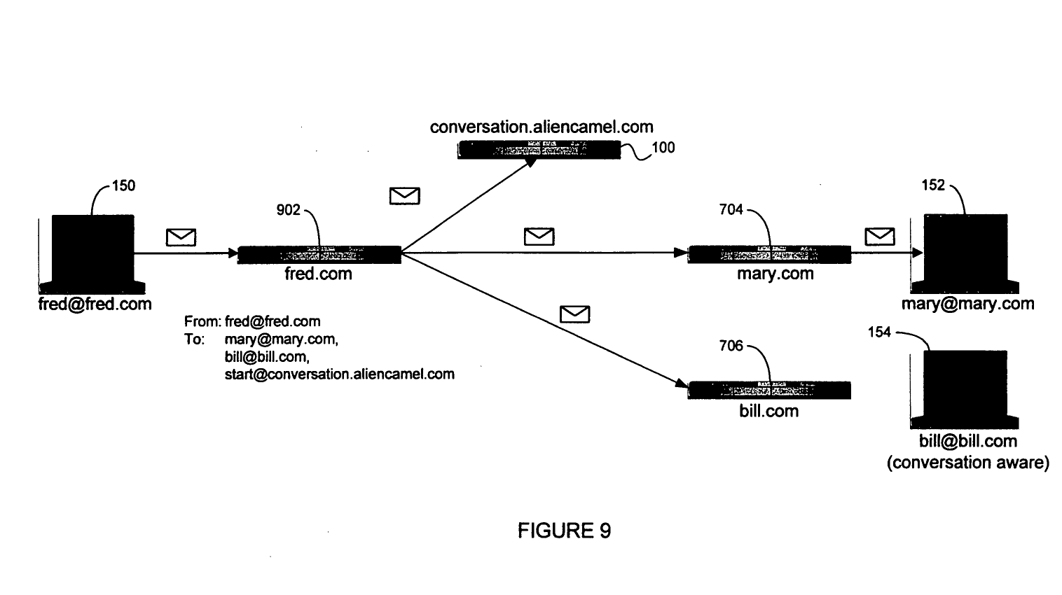

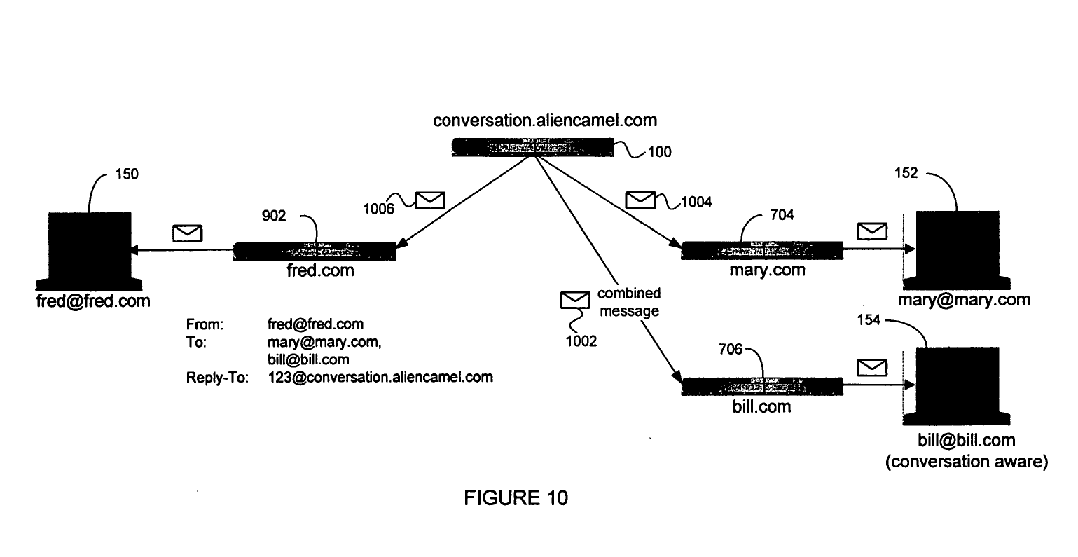

If, as shown in FIG. 9, the email server 902 of Fred's email service is configured so Fred's service is not conversation-aware, but one of the two participants does utilise a conversation-aware email service, then the receipt of two email messages to this participant is prevented. For example, if Bill's email service provider for the domain bill.com is conversation-aware, then the SMTP server 706 for Bill's email service would not deliver the initial creation email from Fred because it would identify it as including the creation email address start@conversation.aliencamel.com. At step 304, the conversation server 100 would determine that Bill's email service is conversation-aware, and the send component 116 would compose a combined email message 1002 that combines Fred's initial message about Sunday lunch together with a notification and welcome advising Bill that Fred has started a conversation using the conversation service, as shown in FIG. 10. For example, the combined email would be:
From: “Fred via Conversation Service” <fred@fred.com>
To: mary@mary.com, bill@bill.com
Reply-to: 123@conversation.aliencamel.com
Subject: Conversation about “Sunday lunch”
What's everyone doing for lunch this Sunday?
By the way, I'm using a new email service that creates a magic email address <123@conversation.aliencamel.com> that will automatically email all of us in the future. All you have to do click “reply”.

This combined email 1002 is only sent to Bill because Mary does not use a conversation-aware email service, in which case the original initiating email is not withheld for Mary (as shown in FIG. 9), and Mary needs to be sent the standard notification email 1004 concerning the conversation, as shown in FIG. 10 (step 308). The loop is repeated for each participant, except the sender, in the initial creation email. The send component 116 also generates a confirmation email 1006 (step 312) which is sent back to the sender initiating the conversation, eg Fred.

The second conversation process also caters for delivery of combined conversation notification messages when a new participant is added to an existing conversation, and either the sender or the new participant uses a conversation-aware email service. For new participants, a conversation-aware email service will receive an email which includes the conversation address, eg 123@conversation.aliencamel.com, in one of the recipient address fields of the email header, and not just in the reply to field, as for existing participants. On recognising this address from the conversation domain in a recipient field, the SMTP server of the conversation-aware email service will discard this email, as a combined message will be sent by the conversation server 100.

As shown in FIG. 4, if an email received by the conversation server 100 is not addressed to the conversation creation address, then the email is handled as described previously for steps 214 to 226, with the exception that step 224 is now performed in a loop performed for each participant identified in the email, except the sender (400).

The send component 116 performs the loop and for each participant determines whether the sender or the participant or both have a conversation-aware email address (412). If so, and the participant is new (step 414), then a combined email is sent including the body of the initial message and a notification explaining the conversation service and including the conversation address (step 420).

The combined message is sent at step 420 as the original email has already been withheld for this participant. If the participant is not new, then an email is generated to forward the message to the participant (422), as discussed for the first conversation process, but where only the participant is addressed as a recipient in the envelope of the email.

For a participant where it is determined that neither the sender or the participant uses an email service that is conversation-aware (412) and it is determined the participant is new (416), then the send component 116 needs to generate a notification email (step 418) which is sent by the email server 106. A combined email is not sent as the original message would not have been withheld by the participant's email service or the sender's email service. If the sender included the participant as a recipient with a discreet email address (424), ie the sender did not intend the participant to be forwarded the message by the conversation server 100, then the participant will receive the email in the normal manner and the loop can proceed to completion at step 428 (for the participant). Otherwise, the message needs to be placed in a forward email for the participant to be sent by the email server 106 (426). The loop is completed for each intended participant in the conversation as identified by the addresses stored for the conversation (428), and then the process completes (430).

The conversation server 100 processes all email messages received and generates emails to be sent using the email server 106. Accordingly, the process components modules 112 to 118 are able to incorporate software applications to detect SPAM and viruses and delete any received. Spam and virus filters, such as ClamAV (http://www.clamav.net/), may be used to filter messages received by the email server 106. Additional security processes can be executed by the server 100. For instance the server 100 may restrict the ability to create conversations to selected users, or send an additional authentication email to new users, thereby confirming their email address.

All messages received are also archived and accessible via the web server 110. Events, such as the addition of new participants to a conversation may also be archived. FIGS. 11 and 12 illustrate access of these archives using a web browser. The web interface may also allow a user to perform the same functions available by email, such as creating new conversations, adding additional participants to existing conversations and sending messages to conversations.

The server 100 may include a facility to allow a user to remove himself from a conversation, either via the web interface or by sending a specific message, such as one with the word “remove” in the subject, to a conversation address.

An alternative embodiment of the server 100 would allow any user to join a conversation by sending an email to an existing conversation address, thereby allowing unrestricted access to public conversations.

In another alternative embodiment, the send component 116 and forward component 118 may send an email to each recipient with a To field that includes only the address of that recipient. The conversation address may or may not be included. This prevents users, who use the Reply All feature of their email client, from sending a reply directly to all participants in the conversation. The list of participants in the conversation may also be included in the body of each message.

Many other modifications will be apparent to those skilled in the art without departing from the scope of the present invention as herein described with reference to the accompanying drawings.

1. A conversation message server, including:
a receive process component for receiving a creation message sent to a creation address;
an establish process component for generating, in response to said creation message, a conversation address, storing other addresses of said creation message as addresses of participants to a conversation corresponding to said conversation address; and
a send process component for sending a conversation notification message to said participants at said addresses to advise of said conversation address.

2. A conversation message server as claimed in claim 1, including a forward process component for forwarding a conversation message received by said receive process component with said conversation address to said addresses of said participants, using said send processing component.

3. A conversation message server as claimed in claim 2, wherein said forward process component processes the conversation message to determine if the conversation message includes any further recipient addresses other than the stored addresses of said participants, and said establish process component stores said further addresses as addresses of further participants to said conversation.

4. A conversation message server as claimed in claim 3, wherein said forward process component and said send process component send said conversation notification message to said further addresses of said further participants.

5. A conversation message server as claimed in claim 1, wherein said conversation notification message includes the content of said creation message for an addressee of said creation message when said addressee will not receive said creation message.

6. A conversation message server as claimed in claim 5, wherein a predetermined process blocks messages including said creation address.

7. A conversation message server as claimed in claim 5, wherein said send component determines said addressee will not receive said creation message based on conversation aware data.

8. A conversation message server as claimed in claim 7, wherein said conversation aware data is included in said creation message.

9. A conversation message server as claimed in claim 7, wherein said conversation aware data is stored by said server and indicates an address of said addressee or a sender of said creation message corresponds to a predetermined process.

10. A conversation message server as claimed in claim 4, wherein said conversation notification message includes the content of said conversation message for an addressee of said conversation message when said addressee will not receive said conversation message.

11. A conversation message server as claimed in claim 10, wherein a predetermined process blocks messages including said conversation address.

12. A conversation message server as claimed in claim 10, wherein said send component determines said addressee will not receive said conversation message based on conversation aware data.

13. A conversation message server as claimed in claim 12, wherein said conversation aware data is included in said conversation message.

14. A conversation message server as claimed in claim 12, wherein said conversation aware data is stored by said server and indicates an address of said addressee or a sender of said conversation message corresponds to a predetermined process.

15. A conversation message server as claimed in claim 2, wherein said conversation message is not forwarded to an address of said participants when the address is included in said conversation message.

16. A conversation message server as claimed in claim 4, wherein said forward process component and said send process component send a new participant message to existing participants notifying of the addition to said conversation of said further participants.

17. A conversation message server as claimed in claim 1, wherein the messages are emails.

18. A conversation process, performed by a computer system, including:
receiving a creation message sent to a creation address;
generating, in response to said creation message, a conversation address, and storing other addresses of said creation message as addresses of participants to a conversation corresponding to said conversation address; and
sending a conversation notification message to said participants at said addresses to advise of said conversation address.

19. A conversation process as claimed in claim 18, including receiving a conversation message sent to said conversation address, and forwarding said conversation message to said addresses of said participants.

20. A conversation process as claimed in claim 19, including processing the conversation message to determine if the conversation message includes any further recipient addresses other than said stored addresses of said participants, and storing said further addresses as addresses of further participants to said conversation.

21. A conversation process as claimed in claim 20, including sending said conversation notification message to said further addresses of said further participants.

22. A conversation process as claimed in claim 18, wherein said creation message, said conversation message and said notification message are respective emails.

23. A conversation message server for performing a process as claimed in claim 18.

24. Computer program code, stored on computer readable memory, for performing a process as claimed in claim 18.

25. A conversation process, performed by a computer device, including:
sending a creation message to a creation address, wherein, in response to said creation message, a conversation address is generated, and other addresses of said creation message are stored as addresses of participants to a conversation corresponding to said conversation address; and
receiving a conversation notification message sent to said participants at said addresses to advise of said conversation address.
